(19) United States
(12) Patent Application Publication
(10) Pub. No.: US 2026/0080685 A1
(43) Pub. Date: Mar. 19, 2026

(54) TRACKING PARKING THROUGH MEDIA-PLAYBACK DEVICES

(71) Applicant: DISH Network Technologies India Private Limited, Bangalore (IN)

(72) Inventors: Srinivasarao Duddu, Bengaluru (IN); Ananda Siddappa, Bengaluru (IN); Sreehari Sajith, Kannur (IN)

(73) Assignee: DISH Network Technologies India Private Limited, Bangalore (IN)

(21) Appl. No.: 18/888,950

(22) Filed: Sep. 18, 2024

(51) Int. Cl. G06V 20/52; G05B 19/42; G06Q 50/10; G06V 20/62

(52) U.S. Cl. CPC G06V 20/52; G05B 19/42; G06Q 50/10; G06V 20/625; G06V 2201/08

(57) ABSTRACT

An example process for monitoring a parking area may include the step of receiving, by a computing device, a video feed from a camera capturing a parking area in a field of view. an image from the video feed includes a license plate of a vehicle. The computing device may look up the license plate to identify a target playback device in response to an owner of the vehicle having access to the target playback device. The computing device may transmit parking data associated with the vehicle to the target playback device. Some embodiments can include a computing device comprising a processor in electronic communication with a non-transitory memory storing instructions thereon that, when executed by the processor, cause the computing device to perform the process. Other examples and related systems, methods, and devices are also disclosed herein.

### TECHNICAL FIELD

The following generally relates to tracking parking. More particularly, the following relates to systems, devices, and automated processes that track parking using a media-playback device.

### BACKGROUND

The rapid urbanization and increased vehicular traffic in modern cities have highlighted significant challenges in parking management, particularly concerning vehicle security, traveler comfort, and check-in efficiency at accommodations. One pressing issue is the vulnerability of parked vehicles to unauthorized access and tampering. Vehicles parked in public or semi-public spaces are at risk of theft, vandalism, and unauthorized entry. Traditional security measures, such as mechanical locks and alarm systems, often fail to provide comprehensive protection or timely notifications to vehicle owners, leaving them anxious about their vehicle's safety. This problem is particularly acute in areas with limited surveillance or insufficient security personnel, where the likelihood of vehicle tampering or theft is higher.

Additionally, travelers frequently face concerns about their vehicle's safety and their own comfort while their vehicle is parked. When individuals park their cars, especially in unfamiliar or potentially less secure locations, they desire reassurance that their vehicle is protected from harm. The absence of effective real-time monitoring solutions exacerbates their discomfort and reduces their overall peace of mind. This lack of confidence can significantly impact the travel experience, as individuals are forced to navigate the stress and uncertainty associated with vehicle security.

Furthermore, the check-in process at hotels and rental properties often introduces its own set of challenges. Travelers frequently encounter delays and inefficiencies when checking in, registering their vehicles, or arranging parking. The process can be cumbersome, particularly when it requires manual entry of vehicle information or additional steps to secure parking. This inefficiency detracts from the convenience and streamlined experience expected by modern travelers, who increasingly seek integrated solutions that can simplify and expedite their arrival and parking arrangements.

### BRIEF SUMMARY

Systems, methods, and devices of the present disclosure may monitor parking areas and notify vehicle owners of status changes. An example process for monitoring a parking area may include the step of receiving, by a computing device, a video feed from a camera capturing a parking area in a field of view, an image from the video feed includes a license plate of a vehicle. The computing device may look up the license plate to identify a target playback device in response to an owner of the vehicle having access to the target playback device. The computing device may transmit parking data associated with the vehicle to the target playback device. Some embodiments can include a computing device comprising a processor in electronic communication with a non-transitory memory storing instructions thereon that, when executed by the processor, cause the computing device to perform the process.

In various embodiments, the target playback device may include a set-back box selected from a plurality of playback devices in response to an association with the license plate. The computing device may register the license plate and the owner to a guest room, and it may check in the owner to the guest room in response to detecting the license plate in the parking area. The computing device may check out the owner from the guest room in response to the license plate being absent from the parking area after an expected checkout time. The example process may include the steps of receiving, by the computing device, a vehicle status from the vehicle, and presenting, by the target playback device, a notification of the vehicle status. The parking data transmitted to the target playback device can comprise the vehicle status. The parking data transmitted to the target playback device may include a notification of activity near the vehicle in the parking area. The parking data transmitted to the target playback device may comprise an image of the vehicle in the parking area. The computing device may detect a change in a status of the vehicle in response to analyzing the video feed, and the target playback device may notify the owner of the change in the status of the vehicle.

An example of a system for monitoring a parking area may include a camera oriented with a parking area in a field of view, and a computing device in electronic communication with the camera. The computing device may be configured to analyze a video feed from the camera to identify a license plate on a vehicle in the parking area. A playback device may be in electronic communication with the computing device. The computing device may look up the playback device associated with an owner of the vehicle using the license plate. The computing device may be configured to transmit vehicle data to the playback device. The playback device may present the vehicle data to the owner.

Various embodiments of the playback device may comprise at least one of a set-top box or a set-back box selected from a plurality of playback devices in response to an association with the license plate. The computing device may be configured to register the license plate and the owner to a guest room. The computing device may be configured to check in the owner to the guest room in response to detecting the license plate in the parking area. The computing device may check out the owner from the guest room in response to the license plate being absent from the parking area after an expected checkout time. The computing device may be configured to detect a change in a status of the vehicle in response to analyzing the video feed. The playback device may notify the owner of the change in the status of the vehicle.

Other examples may be found in the figures, in the claims, or in the description of the present disclosure.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1 illustrates an example computing device, in accordance with various embodiments.

FIG. 2 illustrates an example system for tracking parking at a set-back box (SBB) or other computing device, in accordance with various embodiments.

FIG. 3 illustrates an example process for tracking parking at an SBB or other computing device, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Systems, methods, and devices (collectively, the “System”) of the present disclosure may track parking and parked vehicles. The System may include a camera with a field of view over parking slots in a parking lot, garage, street parking area, or other parking location. The cameras can be equipped with wireless communication capabilities for ease of remote monitoring via a media playback device and display. A camera can focus on the license plate and check the alphanumeric plate characters against a database, for example, of guest license plates expected at a hotel, temporary, or permanent lodging location. The System can display parking and vehicle information using the respective playback device (e.g., in an assigned hotel room) assigned to the guest associated with the detected license plate.

In some embodiments, artificial intelligence (AI) can be integrated into the System. AI can enhance available functions (e.g., expanded notifications, control operations, or monitoring). For example, AI can detect probable unauthorized or suspicious activity using image processing. The System can capture video clips stored at the media playback device associated with the owner or license plate. Continuing the hotel example, notifications, video, or other messages or information can be displayed at the media playback device in the hotel room assigned to the particular guest associated with the license plate. In the hotel example, the System thus tends to enhance customer satisfaction, transparency, and peace of mind.

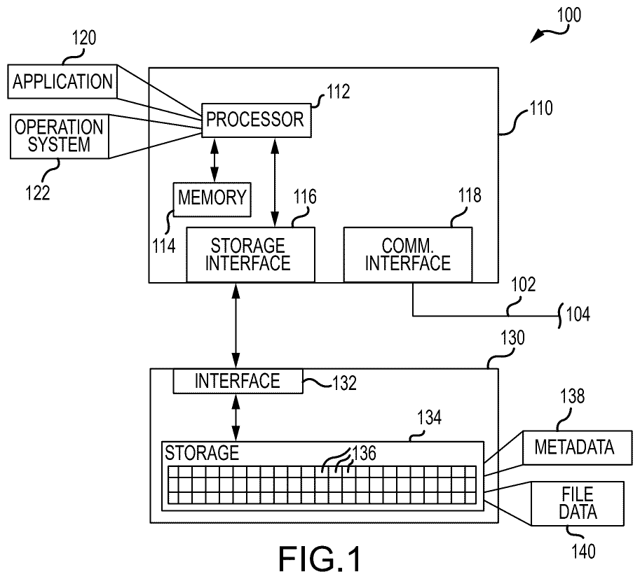

Referring now to FIG. 1, an example computing device 100 is shown, in accordance with various embodiments. Computing device 100 can comprise a laptop, computer, server, smartphone, media-playback device, set-top box (STB), set-back box (SBB), television, placeshifting device, playback device, or other type of computing device compatible with the systems, methods, and devices described herein. In some embodiments, computing device 100 can be an SBB or STB in communication with cameras or other parking sensors.

In various embodiments, computing device 100 may include a processing component 110 and a storage component 130. Computing device 100 may include one or more user interfaces, for input or output such as a keyboard, mouse, track ball, touch pad, touch screen, or a display. Processing component 110 may include a processor 112 and a memory 114. Memory 114 may be in electronic communication with processor 112. Processor 112 may include one or more microprocessors, co-processors, logic devices, or the like. Processor 112 comprising multiple microprocessors may execute in parallel or asynchronously. The logic device may include, for example, analog-to-digital converters, digital-to-analog converters, buffers, multiplexers, clock circuits, or any other peripheral devices required for operation of processor 112.

Memory 114 may include a single memory device or multiple memory devices and may be volatile memory, non-volatile memory, or a combination thereof. In some embodiments, memory 114 may comprise a non-transitory memory configured to store instructions thereon that, when executed by processor 112 or computing device 100, cause the respective processor or computing device to perform operations. The operations can comprise operations or process steps described herein.

In some embodiments, processing component 110 may also comprise a storage interface 116 in electronic communication with processor 112. Storage interface 116 may be configured to provide a physical connection to storage component 130. For example, storage component 130 may comprise an internal hard drive or solid-state storage device. Storage interface 116 may include, for example, appropriate cables, drivers, and the like to enable the physical connection. As a further example, in response to storage component 130 comprising a removable storage medium, such as a CD-ROM drive, DVD-ROM drive, USB drive, memory card, or the like, storage interface 116 may comprise an interface, a port, a drive, or the like configured to receive the removable storage medium and any additional hardware required to operate the interface, the port, the drive, or the like.

Processing component 110 may also comprise a communication interface 118 in electronic communication with processor 112. Communication interface 118 may be, for example, a serial communication port, a parallel communication port, an Ethernet communication port, or the like. Computing device 100 may comprise a communication medium 102. Communication medium 102 may be configured to enable electronic communication between processing component 110 and network 104. Communication medium 102 may be a cable, such as an Ethernet cable. In various embodiments, communication interface 118 may be configured for wireless communication via infrared, radio frequency (RF), WIFI®, optical, BLUETOOTH®, or other suitable wireless communication methods. Communication medium 102 may comprise one or more antennas configured to enable communication over free-space. Network 104 may be an intranet, the Internet, or a combination thereof. Each computing device 100 in a system may communicate with another device either directly or indirectly via a network.

In various embodiments, computing device 100 may be deployed within a system as part of, or to form, a distributed network. The distributed network may be based on one or more computing devices in wireless communication on a network. In some examples, computing device 100 may interact wirelessly over wired communication channels with other computing devices 100 or with other network-enabled devices. For example, cameras or other sensors can communicate over a network with computing device 100. Cameras can stream a video feed or can transmit still images to computing device 100 for display or analysis.

In various embodiments, storage component 130 may comprise any suitable database, data structure, or the like capable of storing and/or maintaining data. Storage component 130 may comprise, for example, a hard drive, a solid-state drive, a removable memory card, and the like. Storage component 130 may comprise an interface 132 configured to enable communications with processing component 110, via storage interface 116. For example, storage interface 116 in processing component 110 and interface 132 in the storage component 130 define the physical layers between the processing component 110 and storage component 130, respectively, establishing communication therebetween. In various embodiments, storage component 130 includes block storage 134, with multiple blocks 136, in which data and files are saved. Each file stored in the storage component 130 may include metadata 138 and file data 140. Metadata 138 for a file includes, for example, pointers to particular blocks 136 in block storage 134 at which the file data 140 for the file is stored.

In some embodiments, metadata 138 can include identifiers assigned to cameras or sensors in communication with computing device 100. In that regard, computing device 100 can communicate with numerous cameras or sensors monitoring a variety of parking spots. Metadata can include a parking spot number, license plate number, user name, vehicle make, vehicle model, vehicle color, vehicle year, or other metadata relevant to monitoring a user's parked vehicle.

In various embodiments, processor 112 in each device 100 may be configured to execute applications 120, as well as an operating system 122 for the device 100. Operating system 122 manages the resources of the device 100 and provides common services between applications 120 executing on processor 112. Operating system 122 may be stored on storage component 130, within memory 114, or a combination thereof. Operating system 122 may vary between devices 100 and is configured to control the hardware components for the associated device 100. Processor 112 may be configured to execute operating system 122 and each of the applications 120 stored in memory 114 or storage component 130.

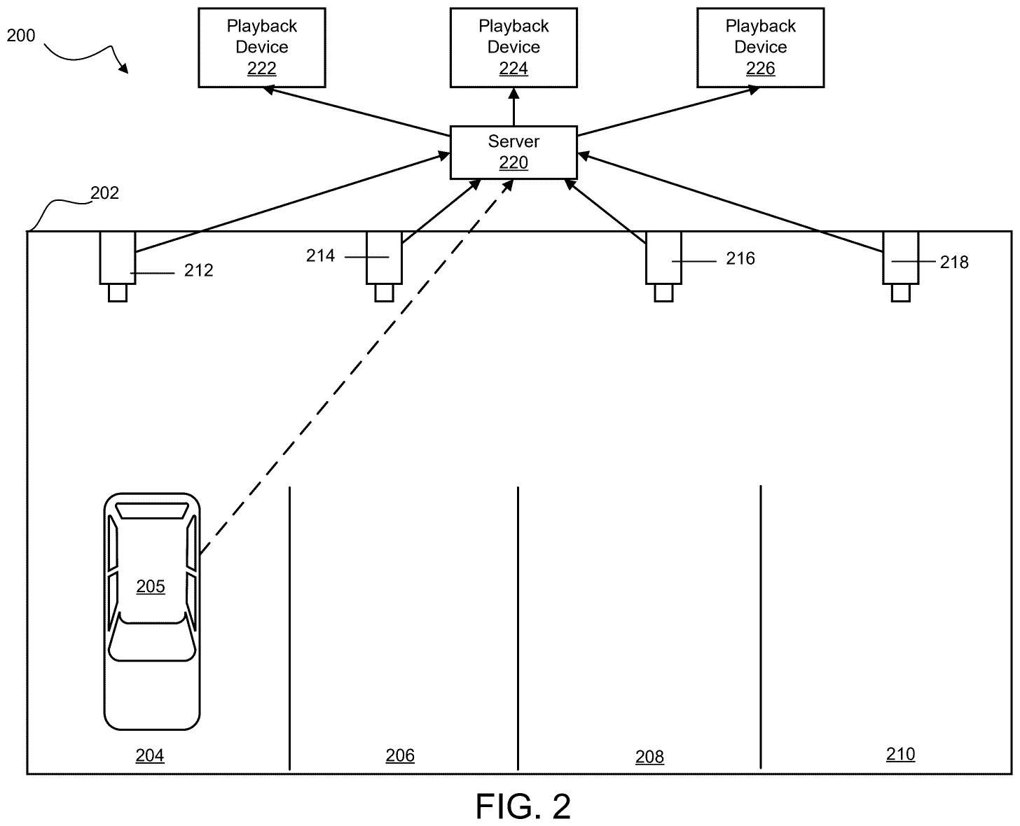

Referring now to FIG. 2, system 200 is shown for monitoring parking, in accordance with various embodiments. In the example of FIG. 2, system 200 includes parking area 202. Parking area 202 can include a parking lot, parking garage, open area, street parking, valet lot, or other type of parking area. Parking area 202 comprises parking spots 204-210.

In various examples, cameras 212-218 can be oriented with a field of view capturing parking spots 204-210. Although cameras are depicted in a one-to-one relationship with parking spots in the example of FIG. 2, any number of cameras can be assigned to any number of parking spots in parking area 202. For example, each spot can have two cameras directed at the spot from a front and a back angle. In another example, on camera can capture three parking spots in its field of view. The images generated by camera typically will have resolution sufficient to accurately identify license plate characters, state, registration status, or other license plate data. In some embodiments, cameras can be oriented towards entrances and exits to parking area 202 to detect vehicles exiting or entering parking area 202 using fewer cameras.

In various embodiments, cameras 212-218 can be strategically positioned to monitor desired parts of parking area 202. Each camera 212-218 can be installed to cover different zones or parking spots 204-210, ensuring comprehensive coverage of parking area 202. Cameras 212-218 can capture high-resolution video footage or still images. Cameras 212-218 can be programmed to focus on predetermined details, such as the license plates of vehicles entering and exiting parking area 202.

In various embodiments, cameras 212-218 can continuously record images of vehicle 205 as it moves through the parking area. Each camera may be connected to server 220 via a wired or wireless communication channel. This connection could be facilitated through a network using Ethernet, Wi-Fi, cellular networks, or Bluetooth, depending on the configuration of parking area 202. Other network or communication technologies could be implemented to facilitate communication between components of system 200. Streams from cameras 212-218 can be sent in real time to server 220. Server 220 is a computing device similar to computing device 100 of FIG. 1. Server 220 may process the video feeds using image processing algorithms.

In some embodiments, server 220 can detect and read license plates from the captured images. Advanced optical character recognition (OCR) technology may be employed to analyze each frame of video, focusing on the license plates of vehicles. The server may scan the images for the characteristic patterns and alphanumeric characters on the plates, extracting license plate data with high precision. Once the license plates are identified, the server can further process this information to perform various functions. For example, server 220 can log the entry and exit times of vehicle 205, track movement of vehicle 205 within the parking lot, monitor for motion or human activity near vehicle 205, or cross-reference the plates of vehicle 205 against a database for access control or security purposes.

Various embodiments include playback devices 222-226 in electronic communication with server 220. Communication can be facilitated through the network again using Ethernet, Wi-Fi, cellular networks, Bluetooth, or other networking technologies. Server 220 can comprise or have access to a database or other data storage structure to connect license plate data with user accounts.

In a hotel-based example, server 220 can store a table of incoming or present guests with their associated license plate numbers or other metadata relating to the vehicle the guest is driving. The database can further associate the identified guest with a room number where the guest will be staying. In some embodiments, the database can include communication data for playback device 224 in the particular room where the guest will be staying. Communication data for playback device 224 can include, for example, a media access control (MAC) address or IP address of media playback device 224. Server 220 can transmit data regarding the identified vehicle and guest only to playback device 224 located in the guest's room. Server 220 can withhold data regarding the identified vehicle or guest from playback devices 222 and 226 that are not associated with the guest or vehicle. System 200 can check a guest into the associated guest room in response to detecting the license plate in the hotel parking area near or after an expected check in time. System 200 can similarly check a guest out of the associated guest room in response to the license plate absent from the parking area near or after an expected checkout time.

In various embodiments, users of system 200 can remotely check their parked car instantly while the vehicle is parked in monitored parking area 202. Users of system 200 can monitor via their associated playback device 224 and check whether their vehicle is in safe condition, is obstructed, is in inclement weather, is tampered with, or otherwise is experiencing conditions of note. In a home-based example, a user of system 200 can remotely control their garage door in addition to monitoring their vehicle by placing server 220 or playback device 224 in electronic communication with the garage door opener. System 200 may be used to document treatment of the user's vehicle during valet services, and system 200 can track the user's vehicle as it moves from the view of some cameras and into the view of other cameras.

In various embodiments, system 200 can provide surveillance and alerting services. System 200 can include an image-processing AI to detect suspicious activities, theft, or damage. The AI can send alerts to security personnel or vehicle owners at their playback devices 222-226 or to their mobile devices. In some examples, system 200 can include remote lock and unlock services to allow car owners to lock or unlock their vehicles remotely using their corresponding playback device 222-226.

System 200 can also be configured with emergency and safety features in various embodiments. For example, parking area 202 can be equipped with a emergency alert system that automatically notifies users and authorities in case of accidents, theft, or other emergencies. Alert systems or other suspicion notifications can be stored in the SBB, STB, or other playback device and popped up once a user turns on the TV.

In various embodiments, system 200 can enable automated valet parking. System 200 can include autonomous vehicles or robots that park cars in designated spaces (e.g., vehicle 205 into space 204), optimizing space usage and reducing parking time.

In some examples, server 220 or an associated playback device 224 can be in communication with electronic systems of vehicle 205. Server 220 or playback device 224 can transmit or receive messages to or from vehicle 205 in such examples. For example, playback device 224 can receive indications from vehicle 205 regarding fuel status, light status, door open status, door lock status, ignition status, or other notifications. Such notifications can be opened by the user or popped up on playback device 224 associated with the vehicle 205.

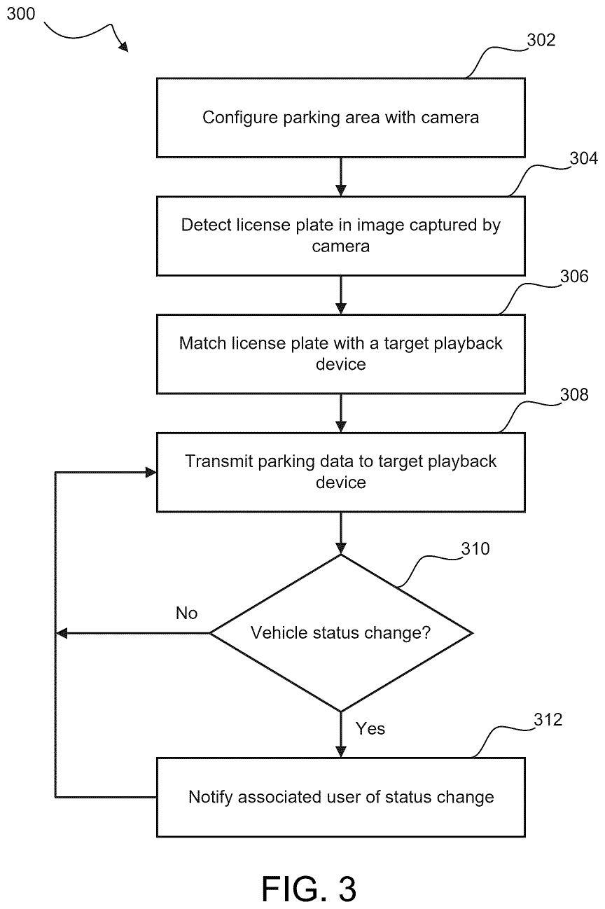

Referring now to FIG. 3, an example process 300 is shown for monitoring vehicles using system 200, in accordance with various embodiments. Process 300 may include configuring parking area 202 with cameras 212-218 (Block 302). Cameras may be selectively placed in parking area 202 to capture desired areas or parking spots within its field of view. Some embodiments can include cameras positioned to capture all or most regions of parking area 202. Some embodiments include cameras positioned to capture entrances and exits. Some embodiments include cameras positioned to capture vehicles parked in designated spaces from the front, from the back, or from other angles likely to include license plate data or vehicle data of interest.

Once cameras are positioned, the cameras may capture video feeds including license plates and vehicles. Server 220 can analyze the camera output to detect license plates (Block 304). Some embodiments can eliminate server 220 from the communication chain and have a camera 212 transmit data regarding vehicle 205 directly to playback device 224 associated with the owner or driver of the vehicle.

In various embodiments, server 220 (or a camera 212) may match a license plate with a target playback device (Block 306). A data file, database, data store, or other data storage structure can associate the license plate number with a system user, with a room, or with a playback device 224. Server 220 can lookup the license plate number in the data storage structure to identify a target destination for data associated with the license plate and vehicle.

In various embodiments, server 220 can transmit parking data to target playback device 224 (Block 308). Parking data can include video clips, live video feeds, images, parking duration, charging duration, ambient conditions at parking spot, human activity near parking spot, tampering near parking spot, or other data related to vehicle 205. In some examples, media playback device 224 can acquire parking data directly from camera 212. The target playback device 224 can store parking data for access by the associated user of system 200.

In various embodiments, server 220 may check whether vehicle status has changed (Block 310). Server 220 may check periodically in some examples, though in other examples server 220 may be continuously processing images or video to detect status changes in real time. In some examples, server 220 can buffer a rolling video segment from each camera of a predetermined duration. For example, server 220 can store a video of the last 10 seconds, the last 30 seconds, the last minute, the last two minutes, or of any other duration. Server 220 can permanently store or transmit (e.g., to playback device 224) the buffered video in response to detecting an event of interest. Examples of events of interest can include parking, departing, a person nearby, inclement weather, a collision, or other events of interest to owners of parked vehicles.

In various embodiments, server 220 may notify an associated user of status change (Block 312). If the display coupled to playback device 224 is on, notifications or popups can be populated on the display for viewing in real-time. In some examples, system 200 can be cellular enabled and can transmit an SMS message or other cellular-based message to the phone number of the user associated with the license plate being monitored.

The System tends to improve peace of mind for owners of parked vehicles and for operators of parking areas. Issues with vehicles can be detected and alerted to their owners in real-time. Supplemental services, such as hotel check in for example, can trigger in response to vehicle status to improve convenience for the driver.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment (for example, A and B, A and C, B and C, or A and B and C).

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S. C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. An automated process comprising:
receiving, by a computing device, a video feed from a camera capturing a parking area in a field of view, wherein an image from the video feed includes a license plate of a vehicle;
looking up, by the computing device, the license plate to identify a target playback device in response to an owner of the vehicle having access to the target playback device; and
transmitting, by the computing device, parking data associated with the vehicle to the target playback device.

2. The automated process of claim 1, wherein the target playback device comprises a set-back box selected from a plurality of playback devices in response to an association with the license plate.

3. The automated process of claim 1, further comprising:
registering, by the computing device, the license plate and the owner to a guest room; and
checking in, by the computing device, the owner to the guest room in response to detecting the license plate in the parking area.

4. The automated process of claim 3, further comprising checking out, by the computing device, the owner from the guest room in response to the license plate being absent from the parking area after an expected checkout time.

5. The automated process of claim 3, further comprising:
receiving, by the computing device, a vehicle status from the vehicle, wherein the parking data transmitted to the target playback device comprises the vehicle status; and
presenting, by the target playback device, a notification of the vehicle status.

6. The automated process of claim 1, wherein the parking data transmitted to the target playback device comprises a notification of activity near the vehicle in the parking area.

7. The automated process of claim 1, wherein the parking data transmitted to the target playback device comprises an image of the vehicle in the parking area.

8. The automated process of claim 1, further comprising:
detecting, by the computing device, a change in a status of the vehicle in response to analyzing the video feed; and
notifying, by the target playback device, the owner of the change in the status of the vehicle.

9. A system for monitoring a parking area, the system comprising:
a camera oriented with a parking area in a field of view;
a computing device in electronic communication with the camera, wherein the computing device is configured to analyze a video feed from the camera to identify a license plate on a vehicle in the parking area; and
a playback device in electronic communication with the computing device, wherein the computing device is configured to lookup the playback device associated with an owner of the vehicle using the license plate, wherein the computing device is configured to transmit vehicle data to the playback device, wherein the playback device is configured to present the vehicle data to the owner.

10. The system of claim 9, wherein the playback device comprises at least one of a set-top box or a set-back box selected from a plurality of playback devices in response to an association with the license plate.

11. The system of claim 9, wherein the computing device is configured to register the license plate and the owner to a guest room, wherein the computing device is configured to check in the owner to the guest room in response to detecting the license plate in the parking area.

12. The system of claim 11, wherein the computing device is configured to check out the owner from the guest room in response to the license plate being absent from the parking area after an expected checkout time.

13. The system of claim 9, wherein the computing device is configured to detect a change in a status of the vehicle in response to analyzing the video feed, and wherein the playback device is configured to notify the owner of the change in the status of the vehicle.

14. A computing device comprising a processor in electronic communication with a non-transitory memory storing instructions thereon that, when executed by the processor, cause the computing device to perform operations, the operations comprising:
receiving, by the computing device, a video feed from a camera capturing a parking area in a field of view, wherein an image from the video feed includes a license plate of a vehicle;
looking up, by the computing device, the license plate to identify a target playback device in response to an owner of the vehicle having access to the target playback device; and
transmitting, by the computing device, parking data associated with the vehicle to the target playback device.

15. The computing device of claim 14, wherein the target playback device comprises a set-back box selected from a plurality of playback devices in response to an association with the license plate.

16. The computing device of claim 14, wherein the operations further comprise:
registering, by the computing device, the license plate and the owner to a guest room; and
checking in, by the computing device, the owner to the guest room in response to detecting the license plate in the parking area.

17. The computing device of claim 16, wherein the operations further comprise checking out, by the computing device, the owner from the guest room in response to the license plate being absent from the parking area after an expected checkout time.

18. The computing device of claim 14, wherein the operations further comprise receiving, by the computing device, a vehicle status from the vehicle, wherein the parking data transmitted to the target playback device comprises the vehicle status, wherein the target playback device is configured to present a notification of the vehicle status to the owner.

19. The computing device of claim 14, wherein the parking data transmitted to the target playback device comprises a notification of activity near the vehicle in the parking area.

20. The computing device of claim 14, wherein the operations further comprise detecting a change in a status of the vehicle in response to analyzing the video feed, wherein the target playback device is configured to notify the owner of the change in the status of the vehicle.
